(19) United States
(12) Patent Application Publication
(10) Pub. No.: US 2021/0254334 A1
(43) Pub. Date: Aug. 19, 2021

(54) METHOD AND FORMWORK FOR PRODUCING A PLATE, AND PLATE

(71) Applicant: SDO ZT GMBH, Graz (AT)

(72) Inventor: Michael OLIPITZ, Graz (AT)

(21) Appl. No.: 17/265,460

(22) PCT Filed: Aug. 1, 2019
(86) PCT No.: PCT/EP2019/070803

§ 371 Date: Feb. 2, 2021

(30) Foreign Application Priority Data
Aug. 3, 2018 (AT) A 50670/2018

(51) Int. Cl. E04C 2/04; E04G 21/18; E04G 11/06

(52) U.S. Cl. CPC E04C 2/044; E04B 1/04; E04G 11/065; E04G 21/185

(57) ABSTRACT

Disclosed is a method for producing a plate, wherein liquid, ultra-high-strength concrete is introduced into a formwork, which delimits a cavity, the cavity consisting of a first, flat region and a second, flat region adjoining the first region, the first and second regions having the same depth and being inclined with respect to one another at a bend angle of 120° to 170°. The concrete is introduced, in particular pumped, into the formwork from the bottom, rises in the formwork and hardens in the formwork in the shape of a bent plate.

### CROSS-REFERENCE TO RELATED APPLICATIONS

This application is the U.S. national phase of International Application No. PCT/EP2019/070803 filed Aug. 1, 2019 which designated the U.S. and claims priority to AT A 50670/2018 filed Aug. 3, 2018, the entire contents of each of which are hereby incorporated by reference.

### BACKGROUND OF THE INVENTION

### Field of the Invention

The invention relates to a method for producing a plate by liquid, ultra-high-strength concrete being introduced into a formwork, which delimits a cavity, wherein the cavity has a first flat region and an adjoining second flat region, which have essentially the same depth and which are inclined with respect to one another at a bend angle of 120° to 170°.

In addition, the invention relates to a formwork for producing a plate from ultra-high-strength concrete, as well as a plate that consists of ultra-high-strength concrete.

### Description of the Related Art

The use of ultra-high-strength concrete for buildings, for example for bridges, or for prefabricated building material, is known and is gaining in importance because of the special properties of ultra-high-strength concrete.

Even when building elements can be produced with ultra-high-strength concrete, which building elements have a thickness that is considerably reduced in comparison to components that consist of conventional concrete, these components must nevertheless have specific wall thicknesses for reasons of strength.

When using ultra-high-strength concrete, its cost, which is several times the cost of conventional concrete, is also disadvantageous. Therefore, despite the advantages of ultra-high-strength concrete, it is often not used due to cost.

### SUMMARY OF THE INVENTION

The object of the invention is to make available a method, a formwork, as well as a plate that consists of ultra-high-strength concrete of the type mentioned in the beginning. In particular, a method is to be provided with which weight-reduced and nevertheless very resilient plates can be produced.

This object is achieved according to the invention with a method that has the features of claim 1, a formwork that has the features of claim 10, and a plate that has the features of claim 14.

Preferred and advantageous embodiments of the invention are the subject matter of the subclaims.

According to the invention, it is provided that the concrete is introduced, in particular pumped, into the formwork from below, rises in the formwork, and cures in the formwork. As a result, the formation of casting defects in the ultra-high-strength concrete is avoided as much as possible, so that thin plates, which also withstand high stress, can be produced with the method according to the invention.

The designation “flat” in the case of the first and second regions of the formwork is defined as meaning that the concrete that is introduced therein has the shape of a flat plate after curing. The plates that are produced with the method according to the invention have—because of the flat regions that are inclined with respect to one another at the bend angle—a bend that runs in a direction or crosswise over the plate.

In particular, within the scope of the invention, an embodiment of the method is preferred in which a pipe or prestressing element that runs through the cavity is arranged in the cavity. The pipe is in particular a sheath, through which, after the plate is produced, at least one stretching wire is pulled and prestressed. Instead of the pipe, a prestressing element, for example at least one stretching wire that is under stress, can also be set in concrete directly into the plate during the production of the plate. Because of the above-mentioned options, prestressing can be introduced into the plate, so that the latter has an expanded span and fewer deformations at high loads.

Embodiments are preferred in which the pipe or prestressing element is arranged to run crosswise over the first region and the second region. Since the bending stiffness of the plate that is produced with the method according to the invention is less around an axis that runs parallel to the bend of the plate than around an axis that runs crosswise to the bend, a more universally resilient plate can be produced by this embodiment of the method.

Within the scope of the method according to the invention, multiple pipes and/or prestressing elements can also be arranged in the cavity before the latter is grouted with concrete, wherein these pipes and/or stretching elements can be arranged at various angles relative to the bend of the plate when necessary.

In a preferred embodiment, before, during, or after the introduction of the concrete and before the concrete cures, at least one connecting element is arranged in the cavity or in the concrete in such a way that after the concrete cures, the connecting element is at least partially surrounded by concrete and is arranged along one edge of the plate that is produced. As a result, a snug connection can be created between the connecting element and the thus produced plate, so that the connecting element is anchored as securely as possible on and in the concrete body.

Within the scope of the invention, an embodiment is preferred in which the formwork is built before the concrete is introduced, by first a plate-like fixed part and a plate-like wing part of a first formwork part that is arranged to pivot thereon being oriented with respect to one another at a bend angle. Then, strip-like formwork elements in the shape of at least one part of the periphery of the plate that is to be produced are arranged at the first formwork part. Finally, a plate-like fixed part and a plate-like wing part of a second formwork part arranged to pivot thereon are arranged on the strip-like formwork elements and thus parallel to the fixed part and wing part of the lower formwork part. With this embodiment, the method can be easily and quickly adapted to the production of differently-shaped plates that are bent in particular by various bend angles.

In a preferred form of extension of the method, for delimiting the cavity, a connecting element is used as at least one of the strip-like formwork elements, wherein this connecting element is at least partially surrounded by concrete after the concrete cures and is part of the plate as a lost formwork. As a result, the plate that has at least one connecting element can be produced in a time-saving manner and eliminating an additional method step, namely the subsequent attachment of the connecting element.

In particular, within the scope of the invention, an embodiment is preferred in which fibers are added to the concrete before the introduction. For this purpose, metal fibers, such as, for example, steel fibers, or synthetic fibers, such as, for example, carbon fibers, are preferably used. Similarly, however, glass fibers, or plastic fibers, such as, for example, polyester fibers, can also be added to the concrete. By adding fibers, it is less likely that cracks will develop in the plate during the process when the concrete cures. Also, the strength of the plate can thus be increased. For the reduction of the formation of cracks when the concrete cures, it is especially advantageous when the concrete is introduced into the formwork at a speed at which the fibers are oriented to run in the plane of the plate or in the conveying direction of the concrete, so that the fibers in the cured concrete run essentially parallel to a top and a bottom of the plate.

When an ultra-high-strength concrete that is packed with fibers is used, it is advantageous when the liquid concrete is introduced into the cavity through a metal pipe, in particular through a steel pipe. Since the fibers do not adhere to the smooth surface of the metal pipe, the concrete can be introduced into the cavity without clumping of the fibers or clogging in the transport region occurring.

In the case of the formwork according to the invention for producing a plate from ultra-high-strength concrete, it is provided that the formwork has a first formwork part and a second formwork part in each case with a fixed part and a wing part that is arranged to pivot on the fixed part via a hinge, wherein in each case the fixed parts and the wing parts of the formwork parts are arranged essentially parallel to one another, wherein strip-like formwork elements are arranged between the formwork parts, and wherein a cavity with an essentially uniform depth is delimited by the formwork parts and the formwork elements.

According to the invention, the cavity of the formwork has a feed opening for the concrete in its lower region. Because it is possible to fill the cavity through the feed opening from below, the plates that are produced with the formwork have fewer casting defects.

Since the cavity is filled from below, the formwork delimits the cavity in any case to the side and downward, but it can be designed at the top to be both open and closed.

The depth of the formwork essentially corresponds to the thickness of a plate, which is produced with the formwork.

In addition, in the case of the formwork according to the invention, the wing parts can be attached to the fixed parts inclined at a bend angle of 120° to 170°. Due to this arrangement, the plates that are produced with the formwork according to the invention have a bend at the preset bend angle, so that the plates that are produced with the formwork according to the invention are more highly resilient.

Embodiments in which the formwork parts and the formwork elements have an airtight formwork skin on their surface that delimits the cavity are preferred. As a result, fibers that were added to the concrete are kept from being introduced into the formwork, escaping, or attaching to the formwork.

By a suitable adjustment of the viscosity of the liquid concrete, moreover, the appearance of fibers on the surface of the plate that is produced with the formwork is prevented, so that the fibers are not exposed to any environmental influences and, in particular in the case of steel fibers, corrode less quickly.

In particular, within the scope of the invention, an embodiment is preferred in which at least one, preferably all, of the strip-like formwork elements runs/run essentially straight. As a result, plates with straight edges can be produced with the formwork according to the invention, which plates can be especially easily arranged on one another and connected to one another.

Within the scope of the invention, it can be provided that at least one of the strip-like formwork elements is a connecting element, which extends with one section into the cavity. This section serves as the connection to the plate, which is produced in the formwork according to the invention, and together with the cured plate as a type of lost formwork is removed from the formwork according to the invention. It is advantageous for the connecting element not to have to be subsequently introduced into the already completely assembled formwork and specially attached.

The plate according to the invention that consists of ultra-high-strength concrete has a first essentially flat section and a second essentially flat section. In addition, the plate has an essentially uniform thickness and at least three, but preferably four or more than four, corners.

The thickness of the plate essentially corresponds to the depth of the formwork, with which the plate is produced.

According to the invention, it is provided that the first section and the second section are inclined with respect to one another at a bend angle of 120° to 170°, wherein the plate has a bend that runs essentially straight. The bend increases the modulus of resistance of the plate against bending and torsion around an axis that runs crosswise to the bend, so that the plate according to the invention will withstand higher stress at smaller thickness than conventional plates of the same thickness without a bend.

An embodiment is preferred in which the plate has at least one pipe or prestressing element that runs into the interior of the plate. As already explained in connection with the method according to the invention, the pipe is in particular a sheath, through which stretching wires or prestressing strands are pulled and prestressed after the plate is produced. Instead of the pipe, a prestressing element in the form of stretching wires or prestressing strands that are under tension can also, however, be set in concrete directly into the plate. As in the method according to the invention, as a result prestressing is introduced into the plate, so that the plate according to the invention has an expanded span and an increased resistance against deformation.

The pipe or prestressing element preferably runs crosswise via the bend, so that the modulus of resistance of the plate is also increased around an axis that runs in the bend direction. The plate according to the invention can also have multiple pipes and/or prestressing elements, wherein these pipes and/or prestressing elements can be oriented at various angles to the bend of the plate when necessary.

The plate preferably has at least one connecting element, which is partially surrounded by concrete and arranged along one edge of the plate. Plates according to the invention that are arranged beside one another can be especially advantageously connected to one another along their edges via such a connecting element.

In a preferred embodiment, pins, hooks, or bolts that project away from the connecting element are arranged on the connecting element. These pins, hooks, or bolts are at least partially surrounded by concrete, so that the connecting element is anchored securely to the plate after the concrete cures.

In a preferred embodiment, fibers, in particular metal or synthetic fibers, preferably steel fibers or carbon fibers, are arranged in the plate. Within the scope of the invention, it is also possible that as fibers, glass fibers, or fibers that consist of plastic, such as, for example, polypropylene or polyester, are used. Preferably, the fibers are essentially in the plate plane or are oriented parallel to the plate plane. Because of the fibers, the concrete of the plate has few cracks, so that the strength of the plate is increased.

According to the invention, a compound structure of plates, in particular of plates according to the described embodiments, is also provided. The plates have connecting elements, which are arranged on respectively one edge of the plates, wherein at least two plates are engaged with one another via at least one connecting element in each case. The connecting elements of the plates that are thus connected to one another, and thus also the plates themselves, can pivot with respect to one another around a pivoting axis and can optionally be fixed in the desired position. Within the scope of the invention, it can be provided that the intermediate space, bridged by the connecting elements, between two plates that are connected to one another is filled with curing material, for example also with ultra-high-strength concrete, in particular with the same ultra-high-strength concrete from which the plates are also produced, so that the plates are connected to one another smoothly and seamlessly.

### BRIEF DESCRIPTION OF THE DRAWINGS

Additional details, features, and advantages of the invention are given in the description below with reference to the accompanying drawings, in which preferred embodiments are depicted. Here:

FIG. 1 shows a top view of a plate according to the invention that is produced according to the method according to the invention,

FIG. 2 shows a sectional view of the plate of FIG. 1 along the sectional plane II-II in FIG. 1,

FIG. 3 shows a diagrammatic depiction of a formwork according to the invention for implementing the method according to the invention,

FIG. 4 shows a detail of the formwork according to the invention in a sectional view,

FIG. 5 shows a detail of a connection of two plates according to the invention in a top view,

FIG. 6 shows a detail of the connection of two plates according to the invention in a sectional view,

FIG. 7 shows a detail of a fastening of a plate according to the invention to a structure in a sectional view,

FIG. 8 shows an isometric view of a compound structure of plates according to the invention, and

FIG. 9 shows an isometric view of another compound structure of plates according to the invention.

### DESCRIPTION OF THE PREFERRED EMBODIMENTS

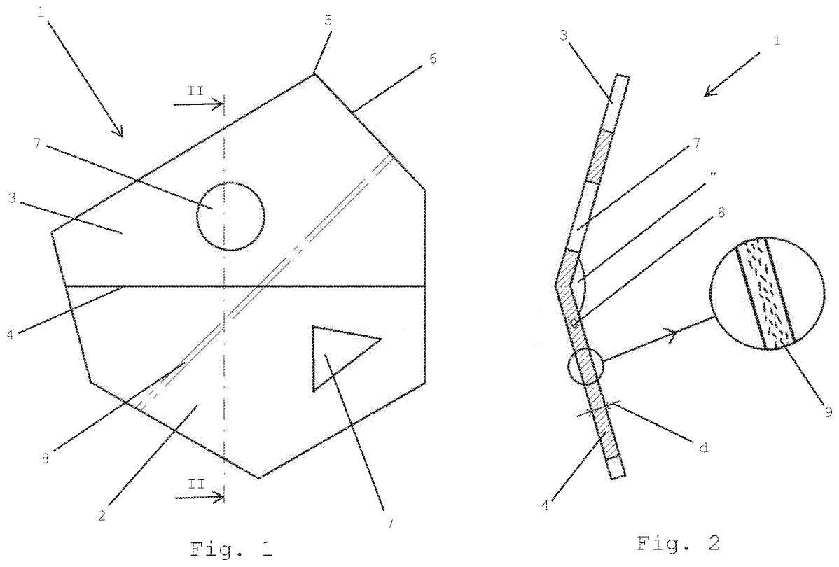

FIGS. 1 and 2 show a plate 1 that is produced with the method according to the invention, one in a diagrammatic top view and one in a sectional view, wherein the section that is depicted in FIG. 2 runs along a sectional area II-II in FIG. 1.

The plate 1 has a first section 2 and a second section 3, which are essentially flat and have a uniform thickness d.

The first section 2 is inclined relative to the second section 3 along a bend 4 that runs crosswise over the plate by a bend angle α.

The plate 1 has multiple corners 5, between which essentially straight edge sections 6 run.

The first section 2 and the second section 3 can in each case have one or more, for example round or angular, through holes 7.

A pipe 8 in the interior of the plate 1 runs over the plate 1 and crosswise (at an angle that is equal or not equal to 90°) via the bend 4. A prestressing element, not shown, can be pulled into the pipe 8, and thus a prestressing force can be introduced into the plate 1.

Within the scope of the invention, other embodiments of plates 1 that deviate from the depicted plate 1 are also possible. For example, the plate 1 according to the invention does not necessarily have to have corners, or it can have more or fewer corners 5, edge sections 6, through holes 7, or pipes 8 than the depicted plate 1. It is also possible within the scope of the invention that some or all of the edge sections 6 do not run straight but rather bent, and/or at least one through hole 7 has a different shape and/or at least one pipe 8 runs differently and/or instead of at least one pipe 8, at least one prestressing element is set in concrete directly into the plate 1.

Fibers 9 can be added to the concrete of the plate 1 before the curing. The latter are preferably oriented essentially parallel to a plane of the plate 1 and are arranged as little as possible or not at all on an edge of the plate 1 but mainly in the interior of the plate 1.

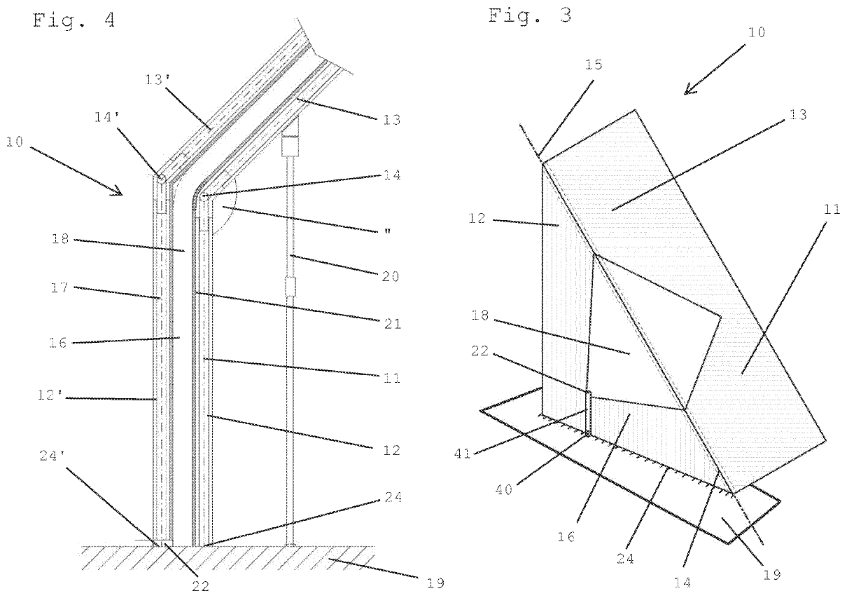

FIG. 3 shows a first formwork part 11 of a formwork 10 according to the invention for the production of a plate 1, in particular the already described plate 1 according to the invention, in a diagrammatic oblique view.

The formwork 10 has a first formwork part 11, which consists of a fixed part 12 and a wing part 13, which are connected to one another via a hinge 14 to pivot around a pivoting axis 15.

Strip-like formwork elements 16 are arranged, for example magnetically attaching, on the first formwork part 11, by which shape and thickness d of the plate 1 that can be produced with the formwork 10 are defined.

A second formwork part 17′—which like the first formwork part consists of a fixed part 12′ and a wing part 13′, which are connected to one another via a hinge 14′ to pivot around a pivoting axis 15′, and which is depicted only in FIG. 4—is arranged parallel to the first formwork part 11.

A cavity 18, which is filled with liquid, ultra-high-strength concrete for producing a plate 1, is delimited by the first formwork part 11, the second formwork part 17, and the strip-like formwork elements 16.

FIG. 4 shows a section through the formwork 10 according to the invention, which is arranged on a base plate 19.

The fixed parts 12, 12′ of the first formwork part 11 and the second formwork part 17 are upright with their lower edge 24, 24′ on the base plate 19 and essentially vertical from the base plate 19, and the wing parts 13, 13′ of the formwork parts 11, 17 are arranged on the fixed parts 12, 12′ in a pivoted manner at the same bend angle α around the hinges 14, 14′.

The strip-like formwork elements 16 that are not depicted in FIG. 4 are arranged between the formwork parts 11, 17, wherein the formwork parts 11, 17 run parallel with respect to one another. The wing parts 13, 13′ are attached in the pivoted position to a holding device 20, which in the depicted embodiment causes the wing part 13 of the first formwork part to rest on the base plate 19.

A preferably airtight membrane 21 that is arranged on the formwork parts 11, 17 and the strip-like formwork elements 16 closes the cavity 18 toward the formwork 10.

The cavity 18 that is formed by the formwork parts 11, 17 and the strip-like formwork elements 16 is filled from below via a fill opening 22 with liquid, ultra-high-strength concrete, so that during filling, the concrete rises upward in the formwork 10. If, as in the case of the embodiment that is depicted in FIG. 3, the cavity 18 does not go up to the lower edge 24, a hose connection 40 is provided between the fill opening 22 and a feed opening 41 in one of the lower formwork elements 16.

After the formwork 10 was filled with concrete, at least one connecting element 23 can be arranged at the upper end of the cavity 18 between the formwork parts 11, 17, in such a way that the connecting element 23 is partially surrounded by concrete after the concrete cures and is arranged along an edge section 6 of the plate 1 that is produced with the formwork 10.

As an alternative or in addition, at least one strip-like formwork element 16 can simultaneously be a connecting element 23, which is connected as a lost formwork in a stationary manner to the plate 1 that is produced in the formwork 10 after the concrete cures and together with the plate 1 is removed from the formwork 10.

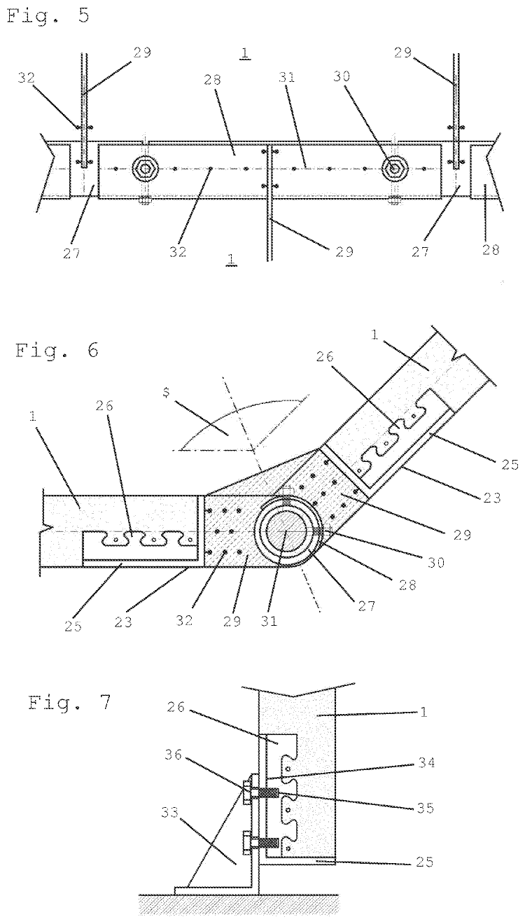

FIGS. 5 and 6 show a connection between two plates 1 via connecting elements 23, one in a top view and one in a sectional view.

The connecting elements 23 that are depicted in FIGS. 5 and 6 have L-shaped strips 25 with anchoring elements 26. The strips 25 are arranged in each case on an edge section 6 of a plate 1 and close the latter, wherein the anchoring elements 26 are surrounded by cured concrete of the plate 1.

The connecting elements 23 have either a cylindrical, in particular hollow, connecting piece 27 or a shell-shaped connecting piece 28 in the shape of a half hollow cylinder. The connecting pieces 27, 28 are connected to the L-shaped strips 25 via arms 29. The shell-shaped connecting piece 28 encompasses the cylindrical connecting piece 27, so that the connecting elements 23 engage with one another.

The connecting elements 23 can be pivoted with respect to one another around an axis 31, which runs parallel to the L-shaped strips and to the edge sections 6, and can be connected in a stationary manner to one another—for example via at least one threaded connection 30—so that the plates 1 are arranged with respect to one another at a selected connecting angle β.

After the plates 1 are connected (not required) to one another at a fixed connecting angle β, the connecting point, which comprises the arms 29 and the connecting pieces 27, 28, can be grouted or covered preferably with concrete, in particular ultra-high-strength concrete. In addition to esthetic reasons, this serves to increase the strength of the connection and the resistance to corrosion of the connecting elements 23 that are arranged at the connecting point.

In order to give the cover coat, preferably that consists of concrete, a better hold on the connecting elements 23 or to ensure a better compound structure of the connecting elements 23 and concrete, connecting means 32 are arranged on the arms 29 and on the shell-shaped connecting pieces 28, which means are arranged in the cured concrete and securely anchor the latter to the connecting elements 23. As connecting means 31, pins, hooks, bolts, or other means can be provided.

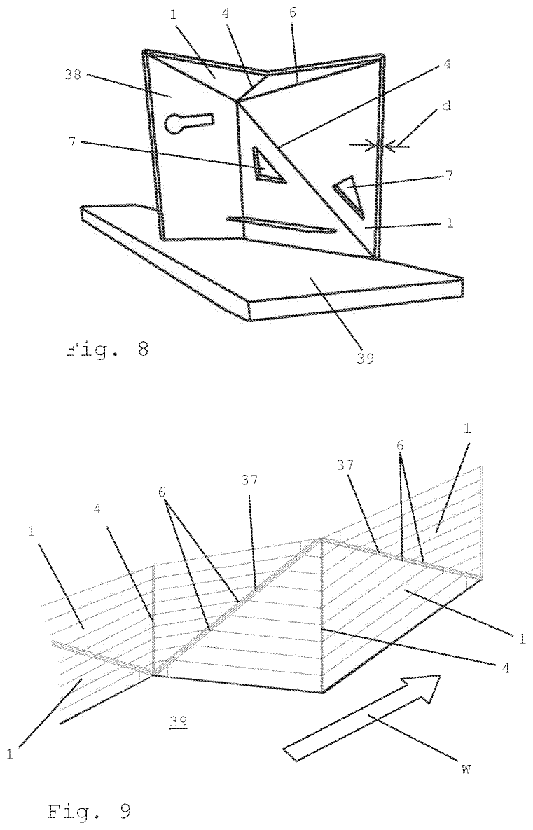

FIG. 7 shows the fastening of a plate 1 to a solid edificial structure 33 via another connecting element 34 in a sectional view. The additional connecting element 34 has, like the already-described connecting element 23, an L-shaped strip 25 and anchoring elements 26 that are arranged thereon.

Unlike the connecting elements 23 for connecting two plates 1, the connecting element 34 that is depicted in FIG. 7 does not have any arms 29 or connecting pieces 27, 28, but rather threaded sleeves 35 for this purpose. Screws 36 can be screwed into these threaded sleeves 35 in order to connect the additional connecting element 34 and thus the plate 1 to a structure 33, for example an edifice or building.

If it is intended to grout or to cover the connecting point between the plate 1 and the structure 33 after the connecting, for example with ultra-high-strength concrete, connecting means 32 can also be provided with an additional connecting element 34.

In each case, FIGS. 8 and 9 show a compound structure of plates 1 according to the invention in an isometric view.

In FIG. 8, two plates 1 according to the invention in combination with a plate 38 that is not in accordance with the invention are arranged on a base 39, for example a sidewalk, in such a way that they form a type of edifice or building, in the depicted embodiment a bus shelter of a bus stop. The plates 1 have, for example, through holes 7 and are connected to one another along edge sections 6, in particular via connecting elements 23. Despite smaller thickness d, the plates 1 have a high stability because of the bent shape of the plates 1 or because of the forming of the bend 4. The plates 1 can be connected to the base 39 or the plate 38 via connecting elements 34.

Depicted in FIG. 9 is a high-water barrier that consists of plates 1 according to the invention, in which the plates 1 are arranged aligned on a base 39, in such a way that a stream of water W is shielded or dammed by the plates 1. The plates 1 whose bend 4 is directed toward the stream of water W are loaded under pressure, and the plates 1 whose bend 4 is directed away from the stream of water W are loaded under tension. Sealing elements 37 run along the edge areas 6, on which the plates 1 are connected to one another, in order to prevent the penetration of water between the plates 1.

Within the scope of the invention, it is possible to arrange plates 1 according to the invention in various compound structures according to the invention, wherein the constructs that are provided in this respect are especially simple while also having higher stability.

1. Method for producing a plate (1) by liquid, ultra-high-strength concrete being introduced into a formwork (10), which delimits a cavity (18), wherein the cavity (18) consists of a first flat region and an adjoining second flat region, which have the same depth and which are inclined with respect to one another at a bend angle (α) of 120° to 170°, wherein the concrete is introduced from below into the formwork (10), rises in the formwork (10), and cures in the formwork (10) in the form of a bent plate (1).

2. The method according to claim 1, wherein before ultra-high-strength concrete is introduced, at least one pipe (8) or prestressing element that runs through the cavity (18) is arranged in the cavity (18).

3. The method according to claim 2, wherein the pipe (8) or prestressing element is arranged to run crosswise over the first region and the second region.

4. The method according to claim 1, wherein before, during, or after the introduction of the concrete and before the concrete cures, at least one connecting element (23) is arranged in the cavity (18) or optionally in the concrete in such a way that after the concrete cures, the connecting element (23) is at least partially surrounded by concrete and is arranged along an edge section (6) of the plate (1) that is produced.

5. The method according to claim 1, wherein before the concrete is introduced, the formwork (10) is built, by:
a plate-like fixed part (12) and a plate-like wing part (13) of a first formwork part (11) that is arranged to pivot thereon being oriented with respect to one another at a bend angle (a),
strip-like formwork elements (16) being arranged at the first formwork part (11) in the shape of at least one part of the periphery of the plate (1) that is to be produced, and
a plate-like fixed part (12′) and a plate-like wing part (13′) of a second formwork part (17) that is arranged to pivot thereon being arranged on the strip-like formwork elements (16) and thus parallel to the fixed part (12) and wing part (13) of the first formwork part (11).

6. The method according to claim 5, wherein for delimiting the cavity (18), a connecting element (23, 24) is used as at least one of the strip-like formwork elements (16), which connecting element is at least partially surrounded by concrete after the concrete cures and is part of the plate (1) as a lost formwork.

7. The method according to claim 1, wherein fibers (9) are added to the concrete before the introduction.

8. The method according to claim 7, wherein the concrete is introduced into the formwork (10) at a speed at which the fibers (9) are oriented to run crosswise to the depth.

9. The method according to claim 7, wherein the liquid, ultra-high-strength concrete that is packed with the fibers (9) is introduced into the cavity (18) through a fill opening (22).

10. Formwork (10) for producing a plate (1) from ultra-high-strength concrete, wherein the formwork (10) has a first formwork part (11) and a second formwork part (17) in each case with a fixed part (12, 12′) and a wing part (13, 13′) that is arranged to pivot on the fixed part (12, 12′) via a hinge (14, 14′), wherein the fixed parts (12, 12′) of the formwork parts (11, 17) are arranged parallel to one another, and the wing parts (13, 13′) of the formwork parts (11, 17) are arranged parallel to one another, wherein strip-like formwork elements (16) are arranged between the formwork parts (11, 17), and wherein a cavity (18) with an essentially uniform depth is delimited by the formwork parts (11, 17) and the formwork elements (16), wherein in a lower region, the cavity (18) has a fill opening (22) for concrete, for filling the cavity (18) from below, and wherein the wing parts (13, 13′) can be attached to the fixed parts (12, 12′) inclined at a bend angle (α) of 120° to 170°.

11. The formwork according to claim 10, wherein the formwork parts (11, 17) and the strip-like formwork elements (16) have an airtight membrane (21) as formwork skin on a surface that delimits the cavity (18).

12. The formwork according to claim 10, wherein at least one of the strip-like formwork elements (16) runs/run essentially straight.

13. The formwork according to claim 10, wherein at least one of the strip-like formwork elements (16) is a connecting element (23, 34), which extends with one section into the cavity (18).

14. Plate (1) that consists of ultra-high-strength concrete, wherein the plate (1) has a first essentially flat section (2) and a second essentially flat section (3), wherein the plate (1) has an essentially uniform thickness (d), and wherein the plate (1) has at least three corners (5), wherein the first section (2) and the second section (3) are inclined with respect to one another at a bend angle (α) of 120° to 170°, so that the plate (1) has a bend (4) that runs essentially straight.

15. The plate according to claim 14, wherein the plate (1) has least one pipe (8) or prestressing element that runs into the interior of the plate (1).

16. The plate according to claim 14, wherein the plate (1) has at least one connecting element (23, 34), which is partially surrounded by concrete and arranged along an edge section (6) of the plate (1).

17. The plate according to claim 16, wherein connecting means (32) are arranged on the connecting element (23, 34), means that project away from the connecting element (23, 34).

18. The plate according to claim 14, wherein fibers (9) are arranged in the plate (1).

19. The plate according to claim 18, wherein the fibers (9) are oriented essentially in a plane of the plate (1) or parallel thereto.

20. Compound structure of the plates (1) according to claim 14, wherein the plates (1) have connecting elements (23, 34), which are arranged respectively on one edge section (6) of the plates (1), and wherein at least two plates (1) are engaged with one another via at least one connecting element (23) in each case, wherein the connecting elements (23) of the engaged plates (1), and thus also the plates (1) themselves, can pivot with respect to one another around an axis (31) and can be fixed in the swiveled position.
